(19) United States
(12) Patent Application Publication
(10) Pub. No.: US 2013/0118196 A1
(43) Pub. Date: May 16, 2013

(54) MOBILE REFRIGERATION EQUIPMENT WITH DC DRIVE

(71) Applicants: Jinhong Chen, Lanxi City (CN); Liming Wang, Lanxi City (CN); Xudong Bao, Lanxi City (CN); Linxiang Yu, Lanxi City (CN)

(72) Inventors: Jinhong Chen, Lanxi City (CN); Liming Wang, Lanxi City (CN); Xudong Bao, Lanxi City (CN); Linxiang Yu, Lanxi City (CN)

(73) Assignee: ZHEJIANG BOYANG COMPRESSOR CO., LTD., Lanxi City, Zhejiang Province (CN)

(21) Appl. No.: 13/811,495

(22) PCT Filed: Jul. 14, 2011
(86) PCT No.: PCT/CN2011/001160

§ 371 Date: Jan. 22, 2013

(30) Foreign Application Priority Data
Jul. 19, 2010 (CN) 201010230856.X

(51) Int. Cl. B60H 1/00

(52) U.S. Cl. CPC B60H 1/00
USPC 62/134

(57) ABSTRACT

A mobile refrigeration equipment with DC drive, comprising a heat preservation library body with inner refrigeration system which compressor is DC variable frequency compressor supplied power by second DC voltage and power supply system which consists of double power DC generator that output the first DC voltage and second DC voltage and battery charging with the second DC voltage. The battery and double power DC generator constitute two kinds of power for DC variable frequency compressor. The power controller is linked among the battery, double power DC generator and DC variable frequency compressor. The power controller at least comprises the power switching module which can achieve that, the DC variable frequency compressor is supplied from double power DC generator automatically turning to battery when the vehicle engine is in low speed operating, and the DC variable frequency compressor is supplied from battery automatically turning to double power DC generator when the vehicle engine is in normal speed operating.

### CROSS REFERENCE TO RELATED PATENT APPLICATION

This patent application is based on Chinese, patent application No. 201010230856.X filed on Jul. 19, 2010, and PCT Patent Application No. PCT/CN2011/001160, filed Jul. 14, 2011.

### FIELD OF THE PRESENT INVENTION

The present invention relates to a mobile refrigeration equipment for transportation, turnaround and frozen food storage.

### BACKGROUND OF THE INVENTION

In recent years, with the improvement of living conditions, the more requirements for the quality and taste of food. The quality of agricultural byproducts foods, such as fruits, vegetables and meat, are directly related to temperature and humidity during the storage and transportation. For this reason, the fresh foods need to be transported to constant heat storage and stored in some specific environment after harvest or processing.

In addition, the monitoring of food safety from state has gradually increased and the management of cold storage and cold-chain has improved step by step. The establishment of cold-chain storage and transportation for food can not just ensure the taste and nutrition of fresh food such as fruits and vegetables. It also can greatly reduce the waste and loss during the transportation because of food spoilage. Now, the domestic and international food mobile refrigeration equipments include the independent refrigeration equipment and dependent refrigeration equipment. The compressor in independent refrigeration equipment is driven by special power device that supply power for refrigeration equipment at the same time. The compressor in dependent refrigeration equipment is driven by power of the vehicle itself, and the normal refrigeration of cold storage needs long-term operation of vehicle main engine. After the temperature reaching the setting temperature in mobile refrigeration equipment, the transmission mechanism of compressor breaks away, then the equipment stops running. The core component of above two kinds of mobile refrigeration equipments is refrigeration compressor which driving way both is conveying the power of engine to compressor directly or indirectly by transmission mechanism. However, the disadvantage is that during the vehicle driving, to the dependent refrigeration equipment, the rotate speed of compressor changes with the rotate speed of engine, then, the compressor bears the speed fluctuation, 700 r/min-8000 r/min. The large amount of refrigerating capacity can not ensure the high-precision refrigeration temperature (the minimum refrigeration temperature difference of refrigeration equipment is about ±2□). Furthermore, the mobile refrigeration equipment needs to supply uninterruptible power source for keeping temperature, namely, the engine needs long-term operation. That is because that the refrigeration compressor, core component of traditional mobile refrigeration equipment, which uses traditional mechanical drive needs engine to supply power source. Once the engine stops, the system can not achieve refrigeration. Compare with the dependent mobile refrigeration equipment, the traditional independent refrigeration equipment runs more stably. Its compressor that is independent of the vehicle engine operation has own power and power supply system. When the vehicle engine stops, the compress can refrigerate with vehicle's own power unit. Although, the refrigeration performance is more stable than the former, it costs greater resources and cost. Meanwhile, the maintenance cost of engine equipment is high.

### SUMMARY OF THE INVENTION

It is therefore an object of the invention to provide a mobile refrigeration equipment with DC drive. The equipment is powered by the double power generator of vehicle itself, and the auxiliary battery uses as a spare power. At the electric supply areas, the switching power of vehicle supplies power source for refrigeration unit to refrigerate whenever the vehicle stopping or running. When the refrigeration equipment is taken out from vehicle, it still independently refrigerate by mains electricity with stable refrigerating capacity and high refrigerating accuracy.

As an embodiment of the present disclosure, a mobile refrigeration equipment with DC drive is provided. The mobile refrigeration equipment with DC drive comprises a heat preservation library body with inner refrigeration system, the inner refrigeration system comprises a condenser, a throttling device and an evaporator linked in sequence; an DC variable frequency compressor powered by a second DC voltage is coupled between the evaporator and the condenser; The mentioned DC variable frequency compressor, the condenser, the throttling device and the evaporator constitute a refrigeration cycle system; The heat preservation library body comprises a power supply system, the power supply system comprises a double power DC generator outputting a first DC voltage and the second DC voltage, and a battery charged by the second DC voltage; The double power DC generator is supplied by vehicle engine, and the first DC voltage output supplies power for vehicle electric equipments; The battery and the double power DC generator constitute two kinds of power for the DC variable frequency compressor; a power controller is linked among the battery, the double power DC generator and the DC variable frequency compressor; The power controller comprises at least a power switching module for switching the power supply of the DC variable frequency compressor from the double power DC generator to the battery automatically when the vehicle engine is in low speed operating, and switching from the battery to the double power DC generator automatically when the vehicle engine is in normal speed operating.

The advantages and spirit related to the present invention can be further understood via the following detailed description and drawings.

Following description and figures are disclosed to gain a better understanding of the advantages of the present invention.

### BRIEF DESCRIPTION OF THE DRAWINGS

FIG. 1 is a schematic diagram of the present disclosure showing a structure of the mobile refrigeration equipment with DC drive.

FIG. 2 is a schematic diagram showing a refrigeration system of the present disclosure.

FIG. 3 is a schematic diagram showing a power supply system of the present disclosure.

FIG. 4 is a schematic diagram showing a double power DC generator of the present disclosure.

FIG. 5 is a schematic diagram showing a power controller of the present disclosure.

FIG. 6 is a schematic diagram showing a generator charging current-limiting module in power controller of the present disclosure.

FIG. 7 is a schematic diagram showing a power switching module and generator excitation regulating module in power controller of the present disclosure.

FIG. 8 is a schematic diagram showing a vacuum speed device of the present disclosure.

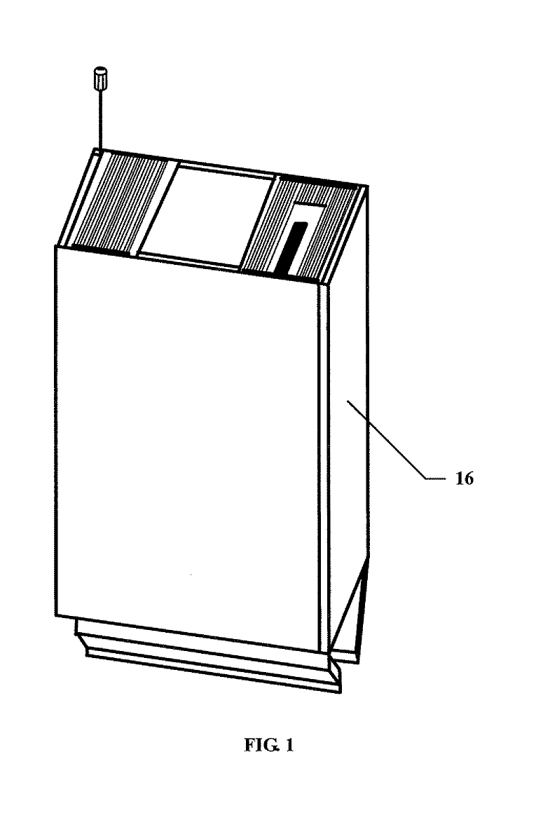

### DETAILED DESCRIPTION OF THE PREFERRED EMBODIMENTS

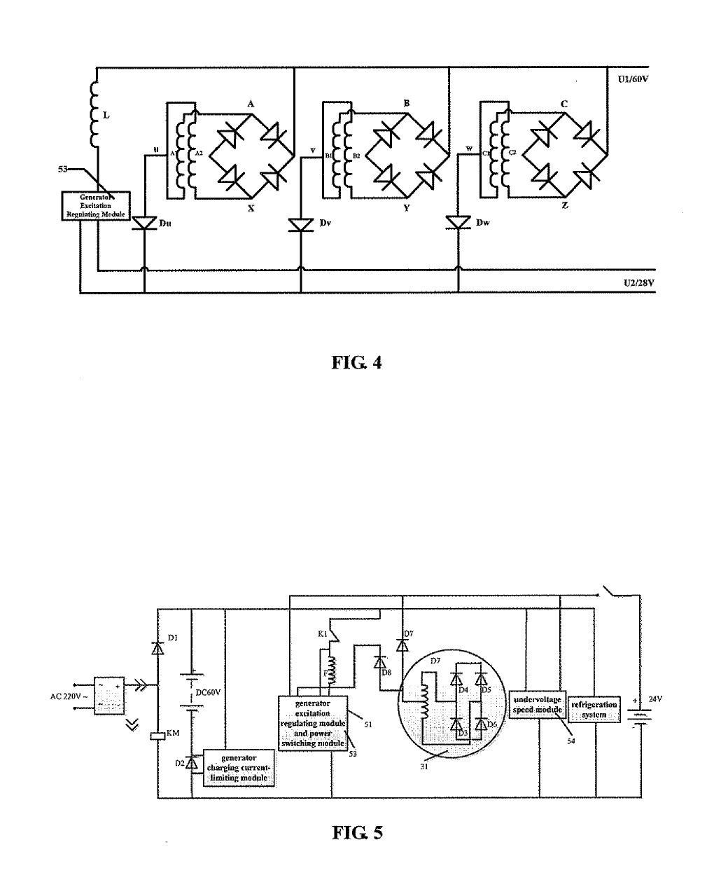

As shown in FIG. 4-FIG. 8, the mobile refrigeration equipment with DC drive comprises a heat preservation library body 16 with an inner refrigeration system, the inner refrigeration system comprises a DC variable frequency compressor 1, a condenser 2, a throttling device 8 and a evaporator 9 linked in sequence cycle. The mentioned DC variable frequency compressor 1 uses DC 60V as a power supply. As an embodiment of the present disclosure, the mentioned throttling device is expansion valve optimally, as well as ordinary balanced expansion valve. The heat preservation library body 16 comprises a power supply system which comprises a double power DC generator 31 that output a first DC voltage and a second DC voltage, and a battery 33 charged by the second DC voltage. The battery 33 and the double power DC generator 31 constitute two kinds of power for the DC variable frequency compressor 1. A power controller S is coupled among the battery 33, the double power DC generator 31 and the DC variable frequency compressor 1. An embodiment of the present disclosure, the vehicle electric equipments are vehicle air-condition, refrigerator, voice box and architectural lamp etc. such electric equipments, and the mentioned first DC voltage is 24V and second DC voltage is 60V.

The mentioned power controller 5 comprises a power switching module 51 which can achieve that, when the vehicle engine in low speed operation condition, the DC variable frequency compressor 1 is supplied by the double power DC generator 31 automatically shifted to the battery 33, and when the vehicle engine in normal speed operation condition, the DC variable frequency compressor 1 is supplied by the battery 33 automatically shifted to the double power DC generator 31. The power switching module 341 calculates the running speed of vehicle engine by testing the voltage changing of double power DC generator 31 in different rotate speed to achieve the automatically switching of power supply in low speed operating and normal speed operating of vehicle engine.

Furthermore, the mentioned power controller 5 comprises a generator charging current-limiting module 52 which can avoid the mentioned vehicle engine and the double power DC generator 31 damaging because of the battery 33 when the load current is too large, and a generator excitation regulating module 53 control the second DC voltage of the double power DC generator 31 output voltage within 56V˜62V in different rotate speed of vehicle engine, and a undervoltage speed module 54 prevents shortage of electricity of battery 33 because of the long-term low speed running (less than the setting speed of the double power DC generator) of vehicle by adding the vacuum speed device 56 on vehicle to improve vehicle engine speed. Therefore, the double power DC generator 31 charges the battery 33 in normal speed operation.

The power controller 5 further comprises a mains electricity charging module 55 that can automatically cut the double power DC generator 31 supply and turn to a mains electricity supply when the mains electricity access. The mains electricity charging module 55 comprises a switching power VC that changing AC mains electricity to 60V DC voltage for the mentioned battery charging. The 60V DC voltage output of switching power VC parallel connects with DC relay KM and the battery 33. The normally-closed contact K1 of mentioned DC relay KM is linked in power supply circuit of double power DC generator excitation coil F. Therefore, when the vehicle generator 31 is in power condition, the AC mains electricity access and the DC relay KM powering on, the normally-closed contact K1 of DC relay KM linked in power supply circuit of double power DC generator excitation coil F breaks off, then, the double power DC generator 31 stops power generation. However, the mains electricity turns to 60V DC voltage for the battery 33 charging by switching power VC. Then the battery 33 supplies power for DC variable frequency compressor 1 of refrigeration system.

Referring to FIG. 4, the functions of double power DC generator 31 are supplying 24V power for ordinary electric equipment in transport vehicle, as well as, 60V power for mobile refrigeration equipment with DC drive to avoid the cost and maintenance problems from installing two generators. This double power DC generator is improved based on the vehicle original excitation type generator. On the common generator stator iron core, parallel wind phase A with winding A1 and A2, phase B with winding B1 and B2 and phase C with winding C1 and C2. The two winding beginning and end three-phase terminals (abcxyz) with winding A1 and A2, winding B1 and B2, winding C1 and C2 connecting end to end output +60V power after three groups of bridge rectifier. At the end to end connections with winding A1 and A2, winding B1 and B2, winding C1 and C2, extracting taps (uvw) output +30V power after three individual diode rectifier. When the double power DC generator is in normal power, this equipment is the dependent mobile refrigeration equipment.

Referring to FIG. 5-FIG. 8, the power controller 5 comprises a power switching module 51, a generator charging current-limiting module 52, a generator excitation regulating module 53, a undervoltage speed module 54 and a mains electricity charging module 55. The generator charging current-limiting module 52 and the Generator excitation regulating module 53 respectively solve the possible problems of too large charging current and too high voltage of a double power DC generator 31 in the operation. The function of the undervoltage speed module 54 is avoiding battery power-lack damage because of battery electricity exhausting in the condition of stopping for a long time, such as traffic jam and shipment, or no mains electricity power, as well as, proving the normal operation of refrigeration equipment.

The mains electricity charging module 55 has a switching power VC. When the switching power VC connects with 220V/380V AC mains electricity, AC mains electricity is turned to DC 60V power. The DC 60V power that switching power VC output supplies power for battery 33, at the same time, the DC relay KM powering on and normally-closed contact K1 breaks off to cut the power supply circuit of generator excitation coil F to avoid the power loss due to the double power DC generator 31 working and burning vehicle power generation equipment in the condition of switching power VC damage. Hence, the mains electricity charging module 55 achieves automatically cutting double power DC generator 31 supply power with AC mains electricity access, and the AC mains electricity turned to 60V DC by switching power supplies power for battery 33, as well as, for mobile refrigeration equipment with DC drive.

a high power diode D1 is set on power supply circuit of switching power VC, DC relay KM keep working for follow current with avoiding mains electricity cutting. When the mains electricity cuts off and no other supply power equipment, the battery 33 supplies power for mobile refrigeration equipment with DC drive.

During the vehicle running, in normal power condition, the double power DC generator 31 outputs DC 24V and DC 60V dual power supply for vehicle electric equipment and battery 33 charging. The direct current from double power DC generator 31 is gotten by bridge rectifier with four diodes D3-D6.

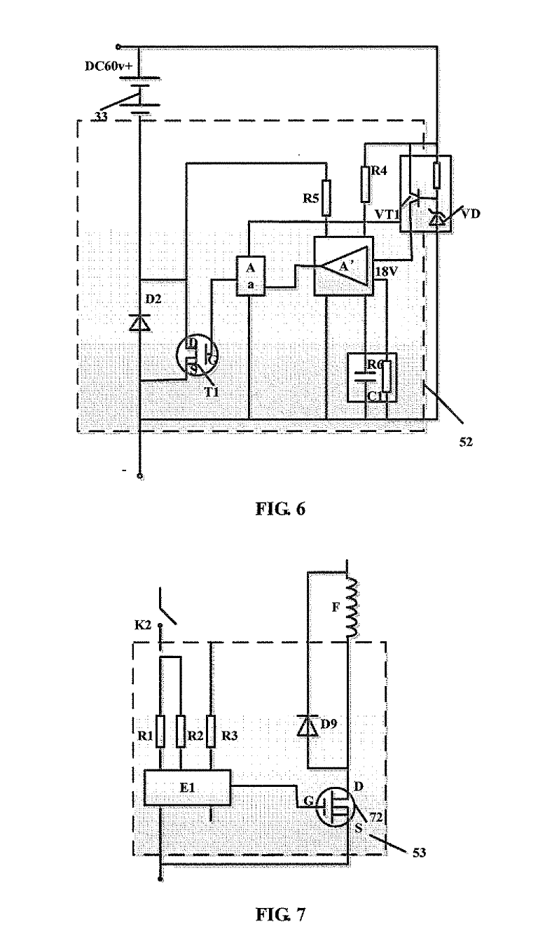

Due to the power limitation of double power DC generator 31, when the mobile refrigeration equipment with DC drive uses battery 33 a long time and double power DC generator 31 for charging, the double power DC generator 31 need to supply power for refrigeration equipment and charge for battery 33. The charging current is more than two times of rated power of double power DC generator. It easily appears double power DC generator damage for overload operation, and large influence on body power. Referring to FIG. 5, adding generator charging current-limiting module 52 consisted with pulse width modulator A′, driver Aa, oscillation circuit C1+R6, field-effect tube VT1 and VR-tube WD within power controller 3. The module principle diagram is shown as FIG. 6. The voltage request for pulse width modulator A′ is high, so the voltage regulator circuit is used to prove stable power voltage. When the double power DC generator 31 does not work and the battery 33 is the power, the negative pole of electric equipment comes back negative pole of battery 33 through high power diode D1. When the double power DC generator 31 works and the battery 33 is the spare power, the power DC generator 31 charges for battery 33, and supplies power for mobile refrigeration equipment with DC drive, meanwhile, the negative pole of double power DC generator 31 is the standard negative pole of this circuit. When the charging current of battery 33 more than the setting current, the current signal reduces by resistance R5 and transports to pulse width modulator A′ which outputs a high frequency signal through oscillation circuit C1+R6. This signal gets a large driving current by controller Aa to control field-effect tube VT1 on (current is more than the setting current) or off (current is less than the setting current) to achieve the control function of charging current limiting.

The voltage of double power DC generator 31 rises with the increase of vehicle engine rotate speed. The high voltage can affect the performance of electric equipment. When the vehicle is in low speed running or shortly sopping, double power DC generator electricity that less than ⅓ rated electricity can not meet requirement of mobile refrigeration equipment and battery. So if the generator power is not enough, like in low speed operation, it needs to cut the generator excitation coil to avoid generator damage for over loading. This power controller only relates to excitation regulating module 53 and power switching module 51.

Referring to FIG. 7, this circuit comprises control chip E1, resistance R1, R2, R3, fly-wheel diode D9, and field-effect tube T2 etc. such main parts.

The power switch opens to connect whole vehicle power supply circuit and supply power for control chip E1 through resistance R2 for reducing voltage. The control chip E1 is controlled by voltage signal from resistance R1 and R3 to control the negative pole of generator excitation coil F on or off for getting stable supply voltage and reducing vehicle loss.

When the generator voltage more than 62V for high rotate speed and the control chip E1 gets voltage signal that more than setting value by R1, the output signal transports to G pole of field-effect tube T2 to cut the negative pole of generator excitation coil F for limiting voltage. At this time, the remainder of generator excitation coil F comes back generator excitation coil F for releasing by fly-wheel loop for voltage stabilization.

The vehicle in low speed running or stopping, the rotate speed of double power DC generator 31 less than 2200 turns, when the output voltage of double power DC generator 31 respectively less than 20V and 42V, the double power DC generator 31 can not meet the requirement of electric equipment, then the control chip E1 gets low voltage (less than setting value) by R3, and the output signal transports to G pole of field-effect tube T2. Cutting the generator excitation coil F, the double power DC generator 31 stops generating electricity, and refrigeration system working with battery 33. However, when the double power DC generator 31 has certain rotate speed with vehicle speed increasing, the control chip E1 gets high voltage (more than setting value) with R3, then the output current signal transports to G pole of field-effect tube T2, and the negative pole of generator excitation coil F switches on, the double power DC generator 31 generates electricity again.

The double power DC generator 31 uses double parallel winding, and the voltage rising and falling are basic synchronous states. Therefore, considering for generality and cost, the standard voltages of generator excitation regulating module 53 and power switching module 51 are tested with 24V voltage from double power DC generator 31.

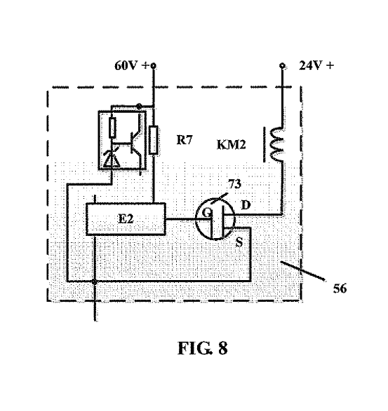

There are some long time stopping and unpredictable conditions, such as traffic jam and shipment etc. during the running process of mobile refrigeration equipment with DC drive, as well as, no mains electricity power. To avoid battery power-lack damage because of battery electricity exhausting and prove the normal operation of refrigeration equipment, add the vacuum speed device 56 that used with vehicle's own speed device to get rotate speed and voltage what double power DC generator 31 needs by automatically improving engine rotate speed after the battery electricity less than certain setting value to supply power for battery and refrigeration for increasing vehicle rotate speed. This device usually comprises vacuum electromagnetic valve KM2 that illustrate referring to FIG. 8. This module consists with undervoltage speed chip E2, resistance R7, voltage regulator circuit WD2, field-effect tube T3 and vacuum electromagnetic valve KM2 etc. components.

The 60V DC voltage gets 5V voltage by voltage regulator circuit WD2 to supply power for undervoltage speed chip E2. The operation voltage of refrigeration system is tested in time by resistance R7. When the power voltage is less than 40V, undervoltage speed chip E2 transports the current signal to field-effect tube T3, the negative pole of vacuum electromagnetic valve KM2 of vehicle switches on, and the double power DC generator 31 normally generates electricity with vehicle engine rotate speed increasing.

To prove stable operation of electric equipment, the D pole and S pole of field-effect tube T3 switch on after the undervoltage speed chip E2 getting undervoltage signal even if the voltage returns normal value until the power shut down and wait the next undervoltage signal. At the same time, DC 60V and DC 24V of double power DC generator 31 are public negative poles.

This power controller 5 can automatically distinguish with 220V/380V AC power access and cut vehicle power generation equipment. Automatically shift to battery supply in the vehicle low speed operation or stopping operation, and double power DC generator 31 supplies power for refrigeration system and charges for battery 33 in the power enough condition, such as high speed running. When the battery 33 voltage is less than protection value, and the double power DC generator 31 dose not reach setting rotate speed, the power controller can automatically improve the rotate speed double power DC generator 31 to achieve intelligent control and reduce fuel consumption of transportation vehicle with proving normal operation of refrigeration system.

The mobile refrigeration equipment with DC drive, as the mobile refrigeration equipment with automatically shifting between independent and dependent can be freely placed at the position other than transportation vehicle and other vehicles. It can achieve double power DC generator supply by easily changing the original excitation generator of vehicle in transportation process and independent operation in low speed operation or short stopping. In addition, after unloading from vehicle or at the place with mains electricity, it can be supplied and charged by common mains electricity. Achieve the aim of operating and charging with mains electricity by following project.

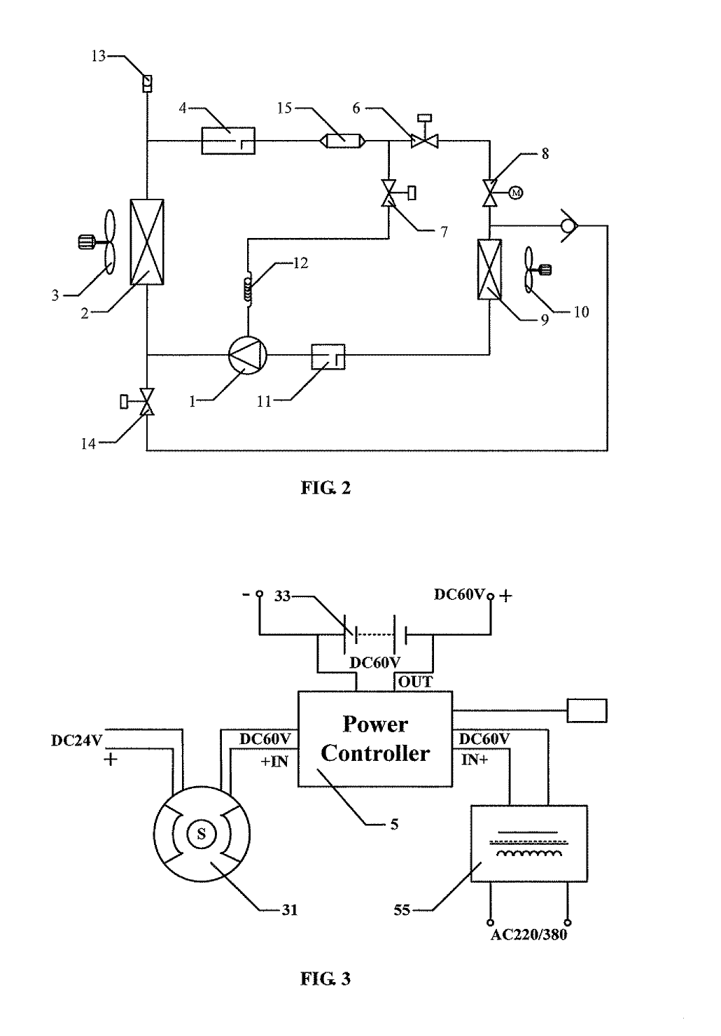

What need to illustrate is that the DC variable frequency compressor 1, condenser 2, throttling device 8 and evaporator 9 are the four necessary components in the refrigeration system of this invention. In the actual refrigeration system, there are some auxiliary equipment except above four components. As FIG. 2 shown, the liquid-storage tank 4, dry filter 15 and electromagnetic 6 that controlling defrost beginning are linked between condenser 2 and throttling device 8, the defrost line which sets one-way valve 15 and defrost electromagnetic valve 14 is paralleled between evaporator 9 input and compressor 1 output, and the gas-liquid separator 11 is linked between evaporator 9 and DC variable frequency compressor 1. To avoid DC variable frequency compressor 1 overheating, the spray liquid cooling electromagnetic valve 7 which function is throttling the liquid refrigerant after condensation through capillary tube and jetting into compressor cylinder for evaporation to control compress temperature no overheating with sacrificing some cold quantity is set on the bypass line between dry filter 15 and throttling device 8. The mentioned evaporator 9 is respectively supported by condensing fan 9 and evaporation fan 10. In refrigeration system, the fusible pug type pressure relief valve is set to discharge refrigerant which press is more than line limit to air for protecting personnel and equipment safety. The mentioned auxiliary equipment of refrigerant has been existing mature technology, here no longer expatiatory.

The technology idea of this invention is that the refrigeration system of mobile refrigeration equipment which is supplied by designed power system is DC variable frequency compressor. This power system comprises double power DC generator that can output the first DC voltage and second DC voltage. The first DC voltage supplies power for the vehicle electric equipment, and the second DC voltage supplies power for DC variable frequency compressor and battery. Optimally, the mentioned first DC voltage is 24V, and the mentioned second DC voltage is 60V. The double power DC generator improved based on the vehicle original excitation type generator is supplied power by vehicle engine. Therefore, the operation speed of vehicle engine impact the supply of double power DC generator. When the vehicle engine is in low speed operation, the double power DC generator possibly appears power supply shortage. To supply stable voltage for DC compressor, it is necessary to change double power DC generator supply to battery supply in the vehicle engine low speed condition. Consequently, the power controller is linked between the double power DC generator and DC variable frequency compressor. The mentioned power controller at least comprises power switching module which can achieve that, when the vehicle engine in low speed operation condition, the DC variable frequency compressor is supplied by double power DC generator automatically shifted to battery, and when the vehicle engine in normal speed operation condition (more than setting speed), the DC variable frequency compressor is supplied by battery automatically shifted to double power DC generator. The power switching module calculates the running speed of vehicle engine by testing the voltage changing of double power DC generator in different rotate speed to achieve the automatically switching of power supply in low speed operating and normal speed operating of vehicle engine.

In addition, the power controller also can achieve charging current limiting and voltage controlling for double power DC generator, and undervoltage speed for vehicle engine.

Moreover, battery also can be supplied by mains electricity. When the vehicle generator is in power condition, the AC mains electricity access, then the DC relay powers on, the normally-closed contact of DC relay linked in power supply circuit of double power DC generator excitation coil breaks off, double power DC generator of vehicle stops power generation. However, the mains electricity turns to second DC voltage for battery charging by switching power. Then the battery supply power for DC variable frequency compressor of refrigeration system.

The compressor of refrigeration system in this invention is DC variable frequency compressor with DC power supply which is supplied by vehicle double power DC generator, and the auxiliary battery as spare power. At the electric supply areas, the switching power of vehicle supplies power source for refrigeration unit. The vehicle engine supplies power for double power DC generator. When the vehicle engine stopping running or in low speed operation, the double power DC generator does not work or insufficiently supply power, then the double power DC generator is supplied by battery charging yet. So it can refrigerate whenever the vehicle stopping or running. Due to the compressor of refrigeration system in this invention is not limited to the vehicle engine with traditional mechanical drive as power source. However there is battery as the spare power. The refrigeration is not limited to the stopping or running of vehicle. The power switching module in power controller can achieve automatically shifting to battery supply when vehicle engine is in low speed operation, such as vehicle short parking, and shifting to double power DC generator again when vehicle engine is in normal speed operation (more than setting speed). So the refrigeration stability is not impacted by vehicle stopping or running or low speed operation of engine due to the uninterruptible power supply, and the power losses of vehicle because of the refrigeration equipment operation are reduced to minimum with largely saving the fuel consumption. The design principle is simple and no sensing equipment on vehicle.

The beneficial effects of this invention are: (1) The power controller can automatically shift power supply according to existing environment to prove the uninterruptible power supply for DC variable frequency compressor and the stable refrigerating capacity. The refrigeration stability is not limited to the stopping or running of vehicle, and the refrigeration precision is high. (2) The equipment can automatically induce mains electricity and work and charge in mains electricity. (3) The refrigeration equipment can still independently refrigerate by mains electricity after moving out of vehicle. (4) The refrigeration system and power supply are integrally designed in heat preservation library body, and the integrated design can achieve modular storage and transportation.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A mobile refrigeration equipment with DC drive, comprising a heat preservation library body with an inner refrigeration system; wherein the refrigeration system comprises a condenser, a throttling device and an evaporator coupled in sequence; a DC variable frequency compressor powered by a second DC voltage is coupled between the evaporator and the condenser; the DC variable frequency compressor, the condenser, the throttling device and the evaporator constitute a refrigeration cycle system; The heat preservation library body comprises a power supply system which comprises a double power DC generator, wherein the double power DC generator outputs a first DC voltage and the second DC voltage, and a battery charged by the second DC voltage; the double power DC generator is supplied by vehicle engine, and the first DC voltage output supply power for the vehicle electric equipments; the battery and the double power DC generator constitute two kinds of power for the DC variable frequency compressor; A power controller is coupled among the battery, the double power DC generator and the DC variable frequency compressor; the power controller at least comprises a power switching module; the power switching module switches to the double power DC generator from the battery to supply for the DC variable frequency compressor when the vehicle engine is in a low speed operating, and switches to the double power DC generator from the battery when the vehicle engine is in normal speed operating.

2. The mobile refrigeration equipment with DC drive as claimed in claim 1, wherein the power switching module calculates the running speed of a vehicle engine by testing the voltage changing of the double power DC generator in different rotate speed to achieve the automatically switching of power supply in low speed operating and normal speed operating of the vehicle engine.

3. The mobile refrigeration equipment with DC drive as claimed in claim 1, wherein the first DC voltage is 24V.

4. The mobile refrigeration equipment with DC drive as claimed in claim 1, wherein the mentioned second DC voltage is 60V.

5. The mobile refrigeration equipment with DC drive as claimed in claim 1, the throttling device is expansion valve.

6. The mobile refrigeration equipment with DC drive as claimed in claim 1, 2, 3, 4, or 5, wherein the power controller comprises:
A generator charging current-limiting module avoiding the mentioned vehicle engine and double power DC generator damaging because of the battery when the load current is too large;
A generator excitation regulating module, controlling the second DC voltage of double power DC generator output voltage within 56V˜62V in different rotate speed of vehicle engine;
An undervoltage speed module, preventing shortage of electricity of the battery as the long-term low speed running of a vehicle by adding a vacuum speed device on vehicle to improve vehicle engine speed, therefore, the double power DC generator charges the battery in normal speed operation.

7. The mobile refrigeration equipment with DC drive as claimed in claim 6, wherein the power controller further comprises a mains electricity charging module that can automatically cut the double power DC generator supply and turn to mains electricity supply when the mains electricity access; and the mentioned mains electricity charging module comprises a switching power (VC) that changing AC mains electricity to second DC voltage for the battery charging; the 60V DC voltage output of switching power (VC) parallel connects with DC relay (KM) and battery; the normally-closed contact (K1) of the DC relay (KM) is linked in power supply circuit of double power DC generator excitation coil (F).
